(19) United States
(12) Patent Application Publication
(10) Pub. No.: US 2008/0295517 A1
(43) Pub. Date: Dec. 4, 2008

(54) EXTRACTION OF NOBLE GASES FROM OCEAN OR SEA WATER

(76) Inventors: Robert J. Howard, Clifton, VA (US); John W. Rapp, Manassas, VA (US)

Correspondence Address: LOCKHEED MARTIN NE&SS MANASSAS, 9500 GODWIN DRIVE, M.S. 400/043, MANASSAS, VA, 20110, US

(21) Appl. No.: 12/130,749

(22) Filed: May 30, 2008

Related U.S. Application Data
(60) Provisional application No. 60/940,887, filed on May 30, 2007.

(51) Int. Cl. F03G 7/05

(52) U.S. Cl. 60/641.7

(57) ABSTRACT

A process includes degassing ocean or sea water in an ocean thermal energy conversion (OTEC) system, and then extracting one or more noble gases from the out-gas of the ocean or sea water. An OTEC system capable of degassing ocean or sea water and extracting noble gases therefrom is also described.

### RELATED APPLICATION

This application claims the benefit of the filing date of U.S. Provisional Patent Application Ser. No. 60/940,887 filed May 30, 2007, which application is incorporated herein in its entirety.

### TECHNICAL FIELD

The present disclosure relates to the extraction of noble gases from ocean or sea water, and in an embodiment, but not by way of limitation, to Ocean Thermal Energy Conversion (OTEC) systems that are configured to extract noble gases.

### BACKGROUND

An Ocean Thermal Energy Conversion (OTEC) system utilizes the differential between the relatively warm upper surfaces of the ocean in the waters around the earth's equator and the colder waters at depths of around 1,000 meters. In a closed OTEC system, a working fluid of relatively low boiling point, such as ammonia, is vaporized in a first section of the system by the warm ocean water. That vaporized working fluid turns a turbine to generate electricity, and the working fluid vapor is then condensed in a second heat exchanger using the colder ocean water that is pumped from a depth of around 1,000 meters.

One problem with current OTEC systems is their relatively low efficiency. Another problem is that the economics of such OTEC systems are heavily tied to the costs of other energy sources such as oil. OTEC systems then become more or less economically viable based on the cost of oil, which over the years has seen many vast and rapid swings in its cost. Consequently, for OTEC systems to become economically viable, other uses of such systems should be considered.

### SUMMARY

In an embodiment, a system includes a pump, a degasser coupled to the pump, a cryogenic refrigeration unit coupled to the degasser, and a fractional distillation unit coupled to the cryogenic refrigeration unit. The pump is configured to pump a source of noble gas-containing water to the degasser. In another embodiment, the pump is a pump in an Ocean Thermal Energy Conversion (OTEC) system that pumps ocean or sea water from a depth to the OTEC system.

### BRIEF DESCRIPTION OF THE DRAWING

FIG. 1 is a block diagram illustrating a process to extract noble gases from ocean or sea water.

FIG. 2 is a block diagram illustrating an embodiment of an Ocean Thermal Energy Conversion (OTEC) and noble gas extraction system.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

Noble gases such as Xenon, Krypton, Neon, and Argon are rare and very expensive. For example, the percentage of Xenon in the air is somewhere around 0.000006 percent. Consequently, Xenon sells for about $100 per gram.

In an embodiment, an out-gas from an Ocean Thermal Energy Conversion (OTEC) cold water flow is used as a feed for degassing, followed by air liquefaction (cryogenic refrigeration), and then fractional distillation. The fractional distillation concentrates and purifies the noble gases. The gas from the degassing step has approximately six times the xenon than that which is found in atmospheric air. Since the noble gases are enriched in the ocean or sea water relative to atmospheric air, the amount of noble gases that are recovered in an OTEC system is consequently much higher as compared with prior recovery techniques. In an open OTEC system, theses noble gases may be further stripped by the vacuum present in the system. While an embodiment is disclosed herein that extracts noble gases from ocean or sea water, the disclosed subject matter could be used in connection with any source of water that includes a viable amount of noble gases therein.

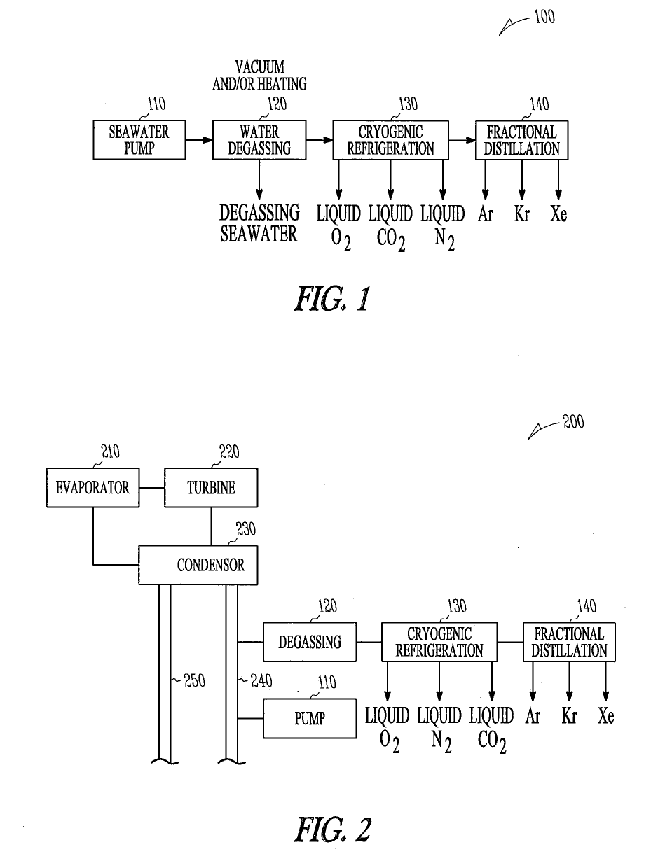

FIG. 1 illustrates a block diagram of an embodiment of an OTEC system 100 that is configured to extract noble gases from the gases dissolved in the ocean water. In the system 100, cold ocean or sea water is pumped at 110 from depths of approximately 1,000 meters up to near the ocean surface. This cold ocean water is used as a cold sink in a condenser or heat exchanger in the OTEC system to condense the working fluid in the OTEC system. A degasser 120 degasses the cold ocean water by a vacuum and/or a heat source. If the ocean water is degassed by heating, it is preferable to degas the ocean water after it has been used to condense the working fluid in the OTEC system. In other OTEC designs, the cold water is degassed by depressurization prior to feeding to the condenser. The products of this degasification have historically been fed into a return cold water pipe or vented to the atmosphere. However, in an embodiment, the products of this degasification can be used as a source for the noble gases. Alternatively, degassing will naturally occur in the heat transfer stages; most notably at the condenser. The gas extracted from the ocean water is then fed into an air liquefaction cryogenic refrigeration unit 130. The cryogenic refrigeration unit generates products such as liquid oxygen, liquid nitrogen, and liquid carbon dioxide. A byproduct of this air liquefaction process is the noble gases, which is then fed into a fractional distillation unit 140 where the noble gases such as argon, krypton and xenon are separated and extracted. Since the concentration of these noble gases is higher in the gases that are dissolved in the ocean water than in atmospheric air, a greater amount of these noble gases is recovered than in prior art processes that use atmospheric air as the source.

FIG. 2 illustrates an example embodiment of an Ocean Thermal Energy Conversion (OTEC) system 200 that includes components that can be configured to extract noble gases from the ocean or sea water as the case may be. The OTEC system 200 includes an evaporator 210, a turbine 220 coupled to the evaporator, a condenser 230 coupled to the turbine, and a cold water feed pipe 240 and a cold water return pipe 250, both coupled to the condenser 230. As is known in the art, such a OTEC system 200 includes a working fluid such as ammonia, which is heated and vaporized in the evaporator 210 by the warm ocean or sea water. The gaseous ammonia is fed into the turbine 220, and the gaseous ammonia turns the turbine, thereby generating a current flow. The ammonia is condensed in the condenser 230, and the cycle is repeated.

Coupled to this typical OTEC system 200 is a pump 110. In an embodiment, the pump 110 is coupled to the cold water feed pipe 240. A degasser 120 is also coupled to the cold water feed pipe 240, a cryogenic refrigeration unit 130 is coupled to the degasser, and a fractional distillation unit 140 is coupled to the cryogenic refrigeration unit. In the OTEC system 200, cold ocean or sea water is brought from depths of approximately 1,000 meters to near the ocean surface by the pump 110. This cold ocean water is used as a cold sink in the condenser 230 (or heat exchanger) in the OTEC system to condense the working fluid in the OTEC system. The degasser 120 degasses the cold ocean water by a vacuum and/or a heat source. If the ocean water is degassed by heating, it is preferable to degas the ocean water after it has been used to condense the working fluid in the OTEC system. The gas extracted from the ocean water is then fed into an air liquefaction cryogenic refrigeration unit 130. The cryogenic refrigeration unit generates products such as liquid oxygen, nitrogen, and carbon dioxide. A byproduct of this air liquefaction process is the noble gases, which is then fed into a fractional distillation unit 140 where the noble gases such as argon, krypton and xenon are separated and extracted. Since the concentration of these noble gases is higher in the gases that are dissolved in the ocean water than in atmospheric air, a greater amount of these noble gases is recovered than in prior art processes that use atmospheric air as the source.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

What is claimed is:

1. A process comprising:
degassing ocean or sea water;
collecting an out-gas from the degassing; and
extracting one or more noble gases from the out-gas.

2. The process of claim 1, wherein the extracting comprises a cryogenic technique.

3. The process of claim 2, wherein the cryogenic technique comprises cryogenic refrigeration to liquefy the out-gas from the degassing and a fractional distillation process to extract the noble gases.

4. The process of claim 1, wherein the noble gases comprise one or more of Xenon, Krypton, Neon, Helium, Carbon Dioxide, and Argon.

5. The process of claim 1, wherein the ocean or sea water is from a cold water flow of an Ocean Thermal Energy Conversion (OTEC) system.

6. The process of claim 1, comprising degassing the ocean or sea water by heating.

7. The process of claim 6, comprising heating the ocean or sea water to degas the ocean or sea water after using the ocean or sea water to condense a working fluid in an Ocean Thermal Energy Conversion (OTEC) system.

8. A system comprising:
a pump;
a degasser coupled to the pump;
a cryogenic refrigeration unit coupled to the degasser; and
a fractional distillation unit coupled to the cryogenic refrigeration unit;
wherein the pump is configured to pump a source of noble gas-containing water to the degasser.

9. The system of claim 8, wherein the pump is coupled to a cold water pipe of an Ocean Thermal Energy Conversion (OTEC) system.

10. The system of claim 9, wherein the pump is configured to receive water from the cold water pipe, and wherein the pump is further configured to pump the water to the degasser.

11. The system of claim 8, wherein the cryogenic refrigeration unit is configured to receive one or more gases from the degasser, and wherein the cryogenic refrigeration unit is configured to generate one or more of liquid nitrogen, liquid carbon dioxide, and liquid oxygen.

12. The system of claim 8, wherein the fractional distillation unit is configured to separate one or more noble gases.

13. The system of claim 12, wherein the noble gases comprise one or more of Xenon, Krypton, Neon, Helium, Carbon Dioxide, and Argon.

14. The system of claim 8, wherein the degasser comprises a heater.

15. An Ocean Thermal Energy Conversion (OTEC) system comprising:
an evaporator;
a turbine coupled to the evaporator;
a condenser coupled to the turbine and to the evaporator;
a cold water pipe coupled to the condenser;
a pump coupled to the cold water pipe;
a degasser coupled to the cold water pipe;
a cryogenic refrigeration unit coupled to the degasser; and
a fractional distillation unit coupled to the cryogenic refrigeration unit.

16. The OTEC system of claim 15, comprising a working fluid in one or more of the evaporator, the turbine, and the condenser.

17. The OTEC system of claim 16, wherein the working fluid comprises ammonia.

18. The OTEC system of claim 15, wherein the degasser comprises a heater.

19. The OTEC system of claim 15, wherein
the pump is configured to supply ocean or sea water to the degasser via the cold water pipe;
the cryogenic refrigeration unit is configured to receive one or more gases from the degasser;
the cryogenic refrigeration unit is configured to extract liquid nitrogen, liquid carbon dioxide, and liquid oxygen from the one or more gases from the degasser; and
the fractional distillation unit is configured to separate one or more noble gases.

20. The OTEC system of claim 19, wherein the noble gases comprise one or more of Xenon, Krypton, Neon, Helium, Carbon Dioxide, and Argon.
